(19) United States
(12) Patent Application Publication
(10) Pub. No.: US 2010/0065510 A1
(43) Pub. Date: Mar. 18, 2010

(54) DESALINATION METHOD AND DEVICE

(75) Inventors: Igor A. Krichtafovitch, Kirkland, WA (US); Vladislav A. Korolev, Renton, WA (US); Nels E. Jewell-Larsen, Corvallis, OR (US)

Correspondence Address: MORRISON & FOERSTER LLP, 1650 TYSONS BOULEVARD, SUITE 400, MCLEAN, VA, 22102, US

(73) Assignee: Kronos Advanced Technologies, Inc., Belmont, MA (US)

(21) Appl. No.: 12/513,648

(22) PCT Filed: Nov. 6, 2007
(86) PCT No.: PCT/US07/83819

§ 371 Date: May 5, 2009

Related U.S. Application Data
(60) Provisional application No. 60/864,591, filed on Nov. 6, 2006.

(51) Int. Cl. B03C 9/00

(52) U.S. Cl. 210/748.01; 210/243

(57) ABSTRACT

A method of water desalination and purification includes steps of flowing salted or contaminated water concentration into a narrow or pointed portion of a corona electrode; applying an electrical potential difference between the water and an opposite electrode; generating a corona discharge in the narrow or pointed portion; evaporating the water; electrically charging water droplets and molecules formed by the evaporating step by means of the corona discharge; moving the charged droplets and molecules toward the oppositely charged electrode; condensing fresh water; and collecting fresh water. A corresponding desalination device includes a corona electrode; at least one attracting electrode; a power supply generating electrical potential difference between the corona electrode and the attracting electrode; and at least one water condensing member.

### CROSS-REFERENCE TO RELATED APPLICATIONS

This application claims the priority of U.S. Provisional Patent Application Ser. No. 60/864,591, filed Nov. 6, 2006, entitled “Desalination Method And Device”, the entire disclosure of which is specifically incorporated herein in its entirety by reference.

### BACKGROUND OF THE INVENTION

1. Field of the Invention

The invention relates to salt water desalination and, in particular, a sea or ocean water desalination and purification.

2. Description of the Related Art
Desalination of ocean water is common in the Middle East and the Caribbean, and is growing fast in the USA, North Africa, Spain, Australia and China. It is also used on ships, submarines and islands where freshwater is not readily available.
   Desalination techniques in use today include:
      Reverse osmosis, which uses pressure to drive water through a membrane, leaving the salt behind;
      Thermal methods use heat to distill water while recapturing heat from vapor condensation; and
      Electrodialysis uses an electrical potential to drive ions through a membrane leaving the water behind.

Reverse osmosis is the process of pushing a solution through a filter that traps the solute on one side and allows the pure solvent to be obtained from the other side. More formally, it is the process of forcing a solvent from a region of high solute concentration through a membrane to a region of low solute concentration by applying a pressure in excess of the osmotic pressure. This is the reverse of the forward or normal osmosis process, which is the natural movement of solvent from an area of low solute concentration, through a membrane, to an area of high solute concentration when no external pressure is applied. The membrane here is semipermeable, meaning it allows the passage of solvent but not of solute.

The membranes used for reverse osmosis have no pores; rather, the separation takes place in a dense polymer layer of only microscopic thickness. In most cases the membrane is designed to allow only water to pass through. The water goes into solution in the polymer of which the membrane is manufactured, and crosses it by diffusion. This process requires that a high pressure be exerted on the high concentration side of the membrane, usually 2-14 bar (30-200 pounds per square inch) for fresh and brackish water, and 40-70 bar [(600-1000 psig)] for seawater, which has around 24 Bar (350 psi) natural osmotic pressure which must be overcome.

In the last decade, membrane processes have rapidly grown, and Reverse Osmosis (R.O.) has taken nearly half the world's installed capacity. Membrane processes use semi-permeable membranes to filter out dissolved material or fine solids. The systems are usually driven by high-pressure pumps, but the growth of more efficient energy-recovery devices has reduced the power consumption of these plants and made them much more viable; however, they remain energy intensive and, as energy costs rise, so will the cost of R.O. water.

The world's largest (reverse osmosis) desalination plant is in Ashkelon, Irael. It began operating on Aug. 4, 2005, and it is capable of producing 100 million cubic meters of water per year.

Forward Osmosis (F.O.) employs a passive membrane filter that is hydrophylic (attracts water), slowly permeable to water, and blocks a portion of the solutes. Water is driven across the membrane by osmotic pressure created by food grade concentrate on the clean side of the membrane. Forward osmosis systems are passive in that they require no energy inputs. They are used for emergency desalination purposes in seawater and floodwater settings.

The thermal method is best known for its use in desalination (removing the salt from sea water to get fresh water) and has been used in this way since the early 1970s. Its first demonstration was done by Sidney Loeb and Srinivasa Sourirajan from UCLA in the California town of Coaling a.

The traditional process used in these operations is distillation—essentially the boiling of water preferably at less than atmospheric pressure, and thus a much lower temperature than normal. Due to the reduced temperature, energy expenditure is minimized and energy is conserved.

In the past many novel desalination techniques have been researched with varying degrees of success. Some are still on the drawing board now while others have attracted research funding. For example, to offset the energy requirements of desalination, the U.S. Government is working to develop practical Solar Desalination. This development has much potential, since the regions in which desalination is most needed often have an abundance of solar energy.

One of the novel techniques of water desalination uses the corona discharge and corona (or ionic wind) for water evaporation. Such techniques are described by Barhakur and Arnold:
Space charges (air ions) produced by a single point-to-plane corona electrode system were used to study the enhancement in the evaporation rates of water at three ion current levels. The maximum evaporation rates of 0.019 and 0.017 g·min⁻¹ were observed at a 1 cm electrode gap for negative and positive air ions, respectively. The cumulative evaporation rates were linear with time and an ion-enhanced rate was about 4 times greater than the control. The current density distribution measurements agreed fairly well with those predicted from the Warburg law. The principal driving force for the observed evaporation enhancement was an ion drag phenomenon which created vortex motions in water when air ions were subjected to an externally applied electric field. Theoretical considerations from derived relationships in fluid mechanics demonstrate that the mass transfer coefficient is higher for positive than negative ions of the same current strength because of the mobility difference between the charges in the medium.
   N. N. Barthakur and N. P. Arnold, “Evaporation rate enhancement of water with air ions from a corona discharge”, International Journal of Biometeorology, Vol. 39, No. 1, PP. 29-33, Abstract (March 1995)

Lai et al. also describe:
The enhancement of water evaporation by electrostatic field (corona wind) has been experimentally studied by the authors of the present invention. The number of the experiments were conducted, with and without cross-flow, at an increment of 1 kV from the corona threshold voltage until the occurrence of sparkover. Two types of electrodes (wire and needle) were used. In addition, both positive and negative corona discharges were applied. The weight loss of water due to evaporation as well as the ambient temperature and humidity were measured. For each case a companion experiment was carried out simultaneously under the same ambient conditions but without the application of electric field. The result of which is used as a basis in the evaluation of the evaporation enhancement using electric field. Each experiment lasted for at least 5 h. With the application of electric field alone, the enhancement in the water evaporation rate increases with the applied voltage. With the introduction of cross-flow, the enhancement in the evaporation rate becomes nearly independent of the applied voltage and is close to the result obtained with cross-flow alone.
   F. C. Lai, M. Huang, D. S. Wong “EHD-Enhanced Water Evaporation”, Drying Technology, Vol. 22, No. 3, PP. 597-608 (2004), Abstract. Both articles are incorporated herein in their entireties by reference.
   Related information may be found in the following patents each of which is incorporated herein by reference in its entirety:

| U.S. Pat. No. | Title |
|---|---|
| 6,991,722 | Hydrate desalination for water purification; |
| 6,830,682 | Controlled cooling of input water by dissociation of hydrate in an |
| | artificially pressurized assisted desalination fractionation apparatus |
| 6,767,471 | Hydrate desalination or water purification |
| 6,508,936 | Process for desalination of saline water, especially water, having |
| | increased product yield and quality |
| 6,475,460 | Desalination and concomitant carbon dioxide capture yielding liquid |
| | carbon dioxide |
| 6,462,935 | Replaceable flow-through capacitors for removing charged species |
| | from liquids |
| 5,124,012 | Process for the desalination of sea and for obtaining energy and the |
| | raw materials contained in sea water |
| 4,293,423 | Process and apparatus for ion exchange by use of thermally regenerable |
| | resin |
| 4,176,779 | Hydraulic inertia centrifugal catalytic desalination device |

### SUMMARY OF THE INVENTION

Embodiments of the present invention provide improved methods of water desalination. According to one embodiment, a corona discharge and ionic wind phenomenon is used to evaporate fresh water from the salted solvent in the corona discharge field region proximate the corona electrode(s). Evaporated water is then condensed on an oppositely charged collecting electrodes.

Another embodiment of the invention uses the ionic wind phenomenon to blow air to a wet oppositely charged electrodes that absorb water by capillary or other forces so that the surfaces of these electrodes are covered with salted or contaminated water. The water is then blown away from the surface of these electrodes as fresh water vapor and condensed at the surface as fresh water.

According to one aspect of the invention, a method of water treatment comprising the steps of:

supplying source water to a corona electrode; applying a high voltage to the corona electrode relative to a collector electrode sufficient to cause a corona discharge; collecting processed water from the collecting electrode.

According to a feature of the invention, the method may further include a step of generating ozone and treating the source water with the ozone.

According to a feature of the invention the source water may include dissolved salt whereby the method includes desalination of the source water to remove substantially all of the dissolved salt.

According to a feature of the invention the source water may include includes contaminants whereby the method includes removal of the contaminants from the source water to provide the processed water.

According to a feature of the invention, the method may further include a step of maintaining a substantially constant level of the source water.

According to a feature of the invention, the method may further include steps of supplying the source water to a constricted portion of the corona electrode; generating a corona discharge in a vicinity of the constricted portion of the corona electrode; evaporating the source water under influence of the corona discharge; transporting the evaporated water to the collecting electrode under influence of an electrostatic field; condensing the evaporated water at the collecting electrode; and collecting the resultant condensate.

According to a feature of the invention the step of evaporating may further include a step of heating the water and/or applying pressure to the source water.

According to a feature of the invention, the method may further include a step of atomizing the source water using an electrospray technique.

According to another aspect of the invention, a method of water desalination and purification, may includes steps of flowing salted or contaminated water concentration into a narrow or pointed portion of a corona electrode; applying an electrical potential difference between the water and an opposite electrode; generating a corona discharge in the narrow or pointed portion;

evaporating the water; electrically charging water droplets and molecules formed by the evaporating step by means of the corona discharge; moving the charged droplets and molecules toward the oppositely charged electrode; condensing fresh water; and collecting fresh water.

According to a feature of the invention, the method may further include steps of generating ozone; and purifying the water with the ozone.

According to a feature of the invention, the step of water evaporating may be enhanced with a thermal process.

According to a feature of the invention, the step of water evaporating may be enhanced by application of pressure to the water.

According to a feature of the invention, the method may further include a step of water atomization created using an electrospray technique.

According to another aspect of the invention, a method of water desalination and purification may include steps of providing a source of salted or contaminated water supply; creating sharp edges using hydrophilic pointed objects; applying a high electrical potential difference between the sharp edges and an opposite electrode; electrospraying and evaporating water from the sharp edges; accelerating water droplets and molecules in a direction of the opposite electrodes; and condensing evaporated water on condensing members as well as in an air gap between the members.

According to another aspect of the invention, a water processing device may include a corona electrode; at least one attracting electrode; a power supply generating electrical potential difference between the corona electrode and the attracting electrode; and at least one water condensing member.

According to a feature of the invention, the attracting electrode and the condensing member may be a single unified component.

According to a feature of the invention, the device may be operable for the desalination and purification of water.

According to a feature of the invention, the device may further include a container filled with the salted or contaminated water; sharp means immersed in the water; an opposite electrode located outside of the water; a power supply for supplying the potential difference between the salt water and the opposite electrode; and a collector for fresh water condensing.

According to a feature of the invention, the device may further include a water supply operating to maintain water level at a substantially constant level.

According to a feature of the invention, the device may further include a mechanism for maintaining the sharp means at a substantially constant level with respect to a water surface.

According to a feature of the invention, the device may further include a mechanism for maintaining substantially constant a distance between the opposite electrodes and a water surface.

Additional objects, advantages and novel features of the invention will be set forth in part in the description which follows, and in part will become apparent to those skilled in the art upon examination of the following and the accompanying drawings or may be learned by practice of the invention. The objects and advantages of the invention may be realized and attained by means of the instrumentalities and combination particularly pointed out in the appended claims.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a diagram in cross section of an electrostatic desalination device according to an embodiment of the present invention;

FIG. 2 is a diagram in cross section of another embodiment of the invention schematic diagram of space heater according an alternate embodiment of the present invention;

FIG. 3 is a photograph of collecting electrodes after 8-10 hours of operation with salt accumulations formed on the surfaces of the electrodes;

FIG. 4 is diagram of an array of nozzles forming a spray of water under influence of an electric field induced in the water by an associated stimulus electrode and corresponding collecting electrode;

FIG. 5A is a diagram of nozzles shown in FIG. 4 prior to application of a high voltage with the water forming a fluid meniscus at equilibrium at the nozzles;

FIG. 5B is a diagram of nozzles shown in FIG. 4 upon application of a high voltage with the water forming Taylor cone at the nozzles;

FIG. 5A is a diagram of nozzles shown in FIG. 4 upon application of a high voltage sufficient to cause an electrospray of the water from the nozzles;

FIG. 6 is a diagram of an electrospray/corona-spray device for desalination and/or sterilization of water according to another embodiment of the invention; and

FIG. 7 is a diagram of another embodiment according to the present invention wherein an electrode assembly floats on and into a surface of a water supply to be treated so as to maintain a designed water level within the assembly and onto the electrodes.

### DETAILED DESCRIPTION OF THE PREFERRED EMBODIMENTS

The ensuing description provides exemplary embodiments only, and is not intended to limit the scope, applicability, or configuration of the invention. Rather, the ensuing description of the exemplary embodiments will provide those skilled in the art with an enabling description for implementing an example embodiment of the invention. It should be understood that various changes may be made in the function and arrangement of elements without departing from the spirit and scope of the invention.

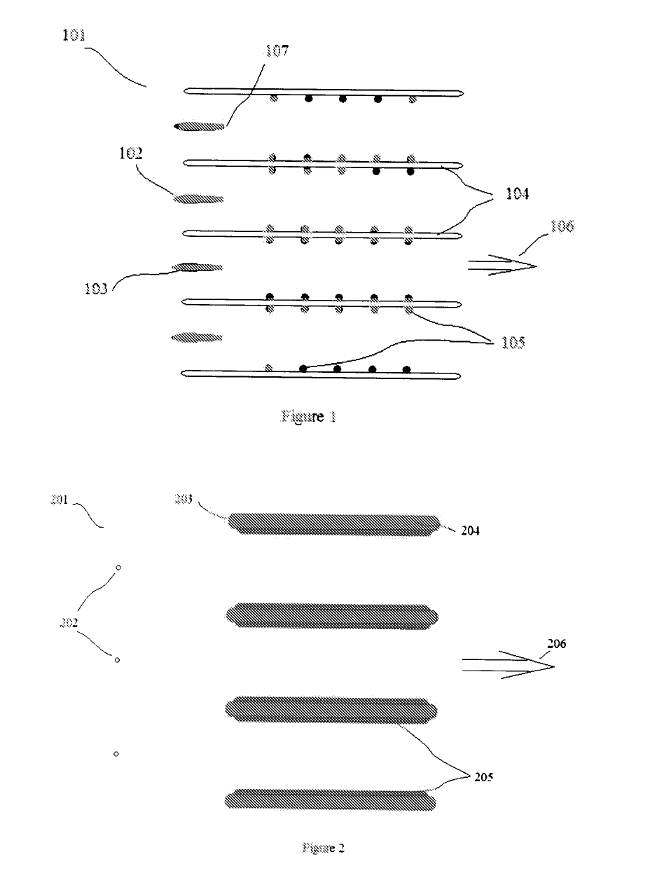

An apparatus and method according to a first embodiment of the invention is illustrated with reference to FIG. 1. The desalinating device 101, shown in cross section, including a number of the corona electrodes 102 and number of the collecting electrodes 104. A high voltage power supply (HVPS) generates/supplies a high voltage potential difference between these groups of the electrodes that is measured in the kilovolts (e.g., from 8 to 60 kV).

Corona electrodes 102 may be conductive or non-conductive hollow tubes (shells). These tubes may take various configurations including cross-sections having a tear-drop like, razor-like, or rod-like configuration, with multiple holes formed therein. Inside of these corona electrodes the salt water or otherwise contaminated water 103 flows under some pressure that ensures the constant water supply and, in some cases, movement. In some implementations the corona electrodes may be made of porous material, e.g., a fibrous material such as thread, having at least one end extending into and immersed in (or otherwise drawing up/transporting) the salt water or otherwise contaminated water. In this implementation the end of the thread should be moved through the salted water constantly due to the fact that it rapidly dries. Part of this salted water comes to the electrodes surface under the force of mechanical pressure (pumps, not shown) or by capillary force. At the corona electrodes' surface or at the holes 107 water comes out. Due to the relatively small hole size 107 water does not spill (i.e., dot's not continue to freely flow out from the holes beyond some initial point such as when water surface tension reaches some level impeding further flow) but protrudes through the edges and is kept there by capillary action/force.

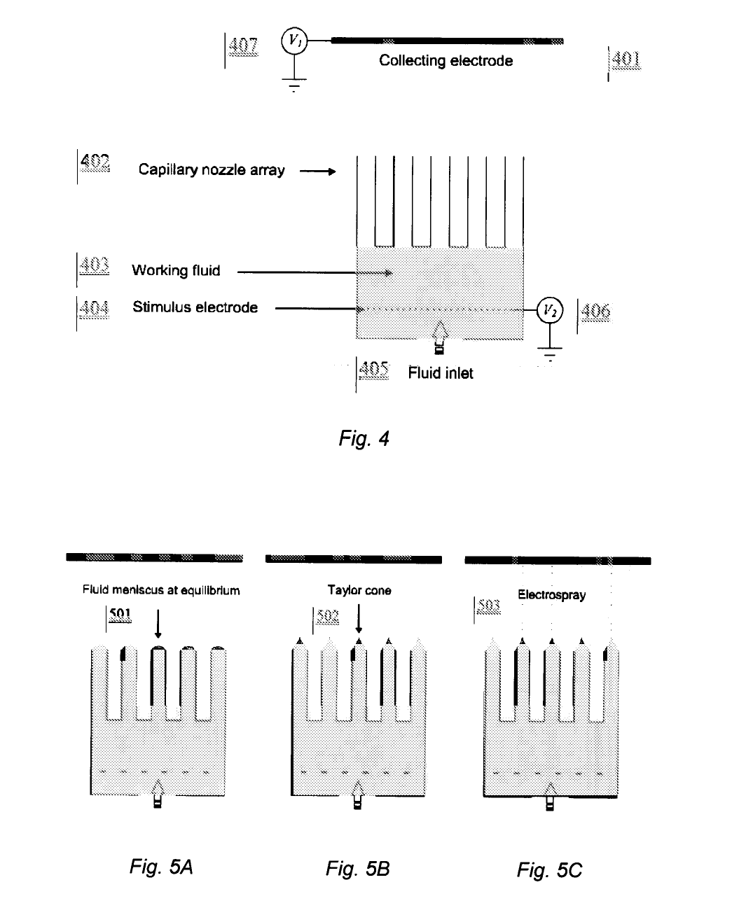

When a suitable high voltage is applied between the corona electrodes 102 and collecting electrodes 104 a corona discharge takes place at the edges of corona electrodes 102. Referring to FIG. 1, the area of the corona discharge is around hole 107. Due to the corona, water starts to evaporate vigorously, i.e. at greater rate than even boiling water (e.g., water heated to boiling under standard atmospheric pressure of 1 bar). The additional pressure brings more water to the hole and maintains a corresponding water feed flow rate supporting an uninterrupted process of water evaporation through the hole. The water micro-droplets are charged with the ions that are generated in the area of the corona discharge and are accelerated toward oppositely charged collecting electrodes 104 (i.e., in the overall direction of ionic wind 106). Collecting electrodes 104 are made of conductive, semi-conductive or insulating material, that do not readily absorb appreciable amounts of water. If an insulating material is used for the surface of corona electrode 102 a conductive electrode should be used within the corona cavity to apply an electric potential to the water inside, similar to the stimulus electrode 404 shown in FIG. 4. Once water begins to accumulate at the surface of collecting electrodes 104, e.g., in the shape of water film or larger water droplets 105, the film or droplets grow larger and, under the force of gravity, flow down along the surface of collecting electrodes 104. Fresh water is then accumulated and collected at the “bottom” of collector electrodes 104. It should be noted that only fresh water evaporates while the salt and contaminants remain at the corona electrodes. These contaminants and salt may be removed from the corona electrodes 102 mechanically or by the flow of more salted or contaminated water.

An apparatus and method according to a second embodiment of the invention is illustrated with reference to FIG. 2 wherein a water desalination is schematically shown. The desalinating device 201, shown in cross section, consists of a number of the corona wire-like (or needle-like, or any other shape suitable for corona discharge) electrodes 202 and number of the collecting electrodes 204. A high voltage power supply (HVPS, not shown) generates potential difference between these groups of the electrodes that is measured in the kilovolt range (e.g., from 8 to 60 kV). Collecting electrodes 204 are made of a porous material (e.g., so as to act as a wick) and have at least one end immersed in salt water or otherwise contaminated water. Under capillary action the salt water elevates (creeps) to a certain height on collecting electrodes 204. If an insulating material is used for the surface of collector electrodes 204 then a conductive electrode should be used within the collector cavity so as to apply an electric potential to the water flowing and held inside the cavity, similar to the stimulus electrode shown in 404 (FIG. 4). Using an insulating material on the surface causes a higher percentage of the ion stream to impact the water leaving the small pores in the surface of the collector, thus increasing evaporation rate and or efficiency.

When a suitable high voltage is applied between corona electrodes 202 and collecting electrodes 204 a corona discharge takes place. Ions are emitted from the vicinity of the corona electrodes and are accelerated toward oppositely charged collecting electrodes thus creating a so called ionic wind 206. The wind blowing along the surfaces of the collecting electrodes blows water away from these surfaces and brings fresh water vapor in the predominant direction of the arrow 206. The salt and contaminants remain on these surfaces and may be periodically or continually removed by mechanical means, flowing water over over/around the electrode, etc The wet air is condensed down in the direction of the arrow 206 (e.g., at a location beyond the attracting electrodes) by one or more collecting surfaces that condense and collect the water vapor (not shown).

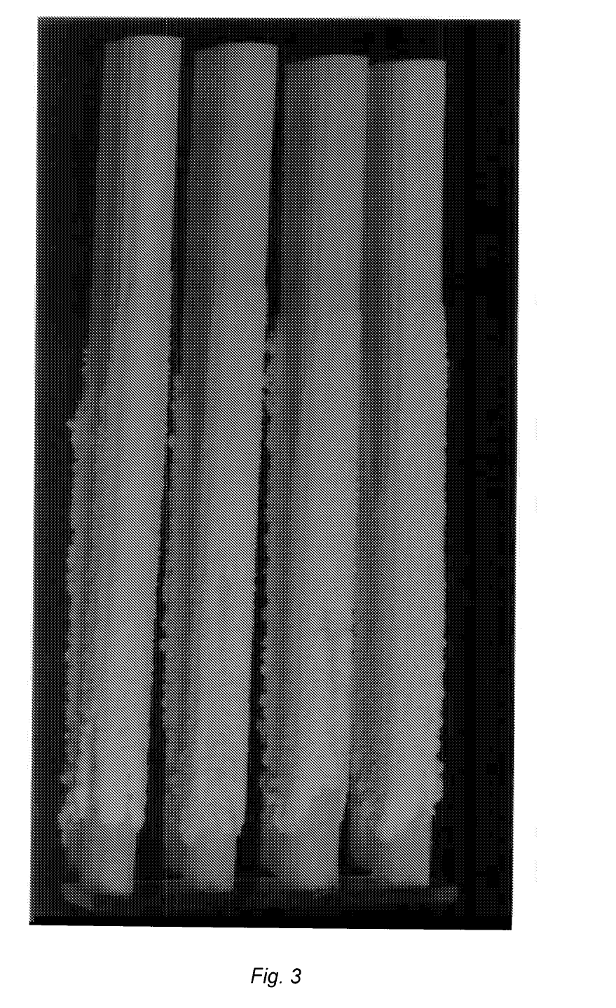

In the FIG. 3 the collecting electrodes according to the above-described second embodiment and corresponding method are shown after being in operation for 8-10 hours. It is clear that most if not all salt remains on the collecting electrodes surface and just fresh water is condensed on (not shown) downstream surfaces.

According to a third embodiment of the invention, a liquid to be processed, such as salt water 402, is sprayed into the air to form fine droplets (e.g., see FIG. 5C and droplet spray 503) and onto collecting electrode 401 where it quickly evaporates, leaving behind the salt that had been dissolved/maintained in solution in the salt water. Evaporation also occurs from the surface of the small spray droplets (e.g., droplet spray 503 of FIG. 5C) as they travel from the spray tip 402 to the collector electrode 402. Because the ions within the electrospray particles tend to be the salt and other contaminants within the water, the salt and contaminants are collected at the collector electrode, while the fresh water is evaporated from the droplets. Fresh water is captured farther down in the process similar as described above in connection with the first embodiment.

A fine water spray is achieved by using corona discharge and/or electrospray of the salty water itself (e.g., FIGS. 5A-5C) at the outlet of the nozzle. In both electrospray mode and corona discharge mode a strong electric field at the nozzle causes charged water particles to accumulate near the surface of the water and push against the water surface thereby deforming it. The water at the nozzle deforms into a cone shaped geometry known as a Taylor cone 502 (FIG. 5). The sharp tip of the cone intensities the electric field at its tip.

FIGS. 5A, 5B and 5C depict three steps or stages of an electrospray operation. FIG. 5A depicts an array of nozzles in an equilibrium state with no electrical field applied. FIG. 5B depicts the nozzles with some small electric field applied, the field intensity only sufficient to create a Taylor cone formation at the tip of each nozzle. However, is the electric field strength is below of electrospray onset level, no droplets are emitted and no spray is formed. FIG. 5C depicts the nozzles with a high intensity electric filed applied, i.e., a field intensity at least equal to an electrospray onset level. At this field level, elecrospray droplets are sprayed from the nozzles to the collecting electrodes where they rapidly evaporate.

Thus, as described above, at an electrospray threshold voltage, small particles of the liquid are shot from the tip of the Taylor cone through the air onto the collecting electrode(s). When the voltage between the working fluid 406 and the collector electrode 407 is increased a corona discharge appears on the tip of the Taylor cone ionizing air surrounding the Taylor cone as well as the liquid causing both air ions and liquid particles to be propelled through the air to the collecting electrode. If nozzle 402 is conductive, a corona discharge can also be formed along the end of the nozzle, as well as being formed on the tip of the Taylor cone. The small particle droplets being ejected from the nozzle 503 are exposed to a very high field intensity and ozone is generated by the corona discharge. The exposure to both a high intensity electric field and ozone acts to sterilize the water in the droplet. Using this process, salt water 403 can be both sterilized and desalinated. Since the rate of water spray can be carefully controlled by varying water pressure and applied voltage, the volume of desalinated water can be carefully regulated. The electrospray/corona discharge spray implantation of the desalination/sterilization method is shown in FIGS. 4 and 5, where the water is passed through an array of nozzles 402 that spray onto a collecting surface 401 where the salt is captured leaving behind a fresh water vapor that can then be captured. According, to an embodiment, hear may also be applied to collecting electrode 401 to accelerate the evaporation process.

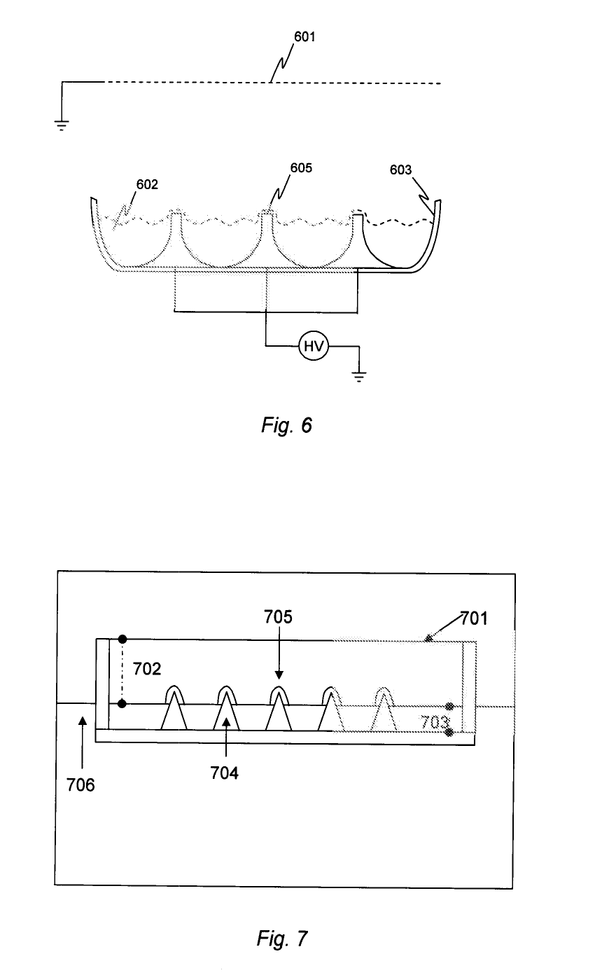

FIG. 6 shows a second implementation of the electrospray/corona-spray desalination and sterilization process. In FIG. 6, rather than using a nozzle 402 which may be subject to clogging and plugging issues, water is drawn up through capillary action on a surface 603 which causes the water 602 to form into a point 605, in a manner similar to as if it had been put through a nozzle. The result is similar to that described above wherein the fluid at the surface of the tip is electrosprayed toward and onto collecting electrode 601, except in this method the nozzle is replaced with a structure 603, which can wick up water off the surface of the water through capillary action. A voltage applied 604 to this could be positive, negative, or alternating (AC).

In one implementation of this approach, as shown in FIG. 7, a floating structure which contains the electrospray structures 704 and collecting electrode 701. The assembly can be floated on the surface of the water 706, so as the absolute depth of the water reservoir changes, the critical depth 703 and 702 of the electrospray structures 704 with relation to the water surface 706 and collector electrode 701 respectively is maintained substantially constant. It should be noted that another means is implemented in the current invention that maintains essentially same water level thus ensuring the same distance between the electrospray structures 704 and the collecting electrodes 701.

It should be noted and understood that all publications, patents and patent applications mentioned in this specification are indicative of the level of skill in the art to which the invention pertains. All publications, patents and patent applications am herein incorporated by reference to the same extent as if each individual publication, patent or patent application was specifically and individually indicated to be incorporated by reference in its entirety.

It is further noted that certain of Applicants' prior disclosures are likewise considered to be applicable to the technical field of the present invention and to various embodiments, implementations, and aspects thereof, including:

| | | Patent or Pub. | |
|---|---|---|---|
| Ser. No. | Filing Date | No. | Title |
| 09/419,720 | Oct. 14, 1999 | 6,504,308 | Electrostatic Fluid Accelerator |
| 10/175,947 | Jun. 21, 2002 | 6,664,741 | Method Of And Apparatus For |
| | | | Electrostatic Fluid Acceleration |
| | | | Control Of A Fluid Flow |
| 10/188,069 | Jul. 3, 2002 | 6,727,657 | Electrostatic Fluid Accelerator For |
| | | | And A Method Of Controlling |
| | | | Fluid Flow |
| 10/295,869 | Nov. 18, | 6,888,314 | Electrostatic Fluid Accelerator |
| | 2002 | | |
| 10/352,193 | Jan. 28, 2003 | 6,919,698 | Electrostatic Fluid Accelerator For |
| | | | And Method Of Controlling A |
| | | | Fluid Flow |
| 10/187,983 | Jul. 3, 2002 | 6,937,455 | Spark Management Method And Device |
| 10/735,302 | Dec. 15, 2003 | 6,963,479 | Method Of And Apparatus For |
| | | | Electrostatic Fluid Acceleration |
| | | | Control Of A Fluid Flow |
| 10/847,438 | May 18, 2004 | 7,053,565 | Electrostatic Fluid Accelerator For |
| | | | And A Method Of Controlling |
| | | | Fluid Flow |
| 11/210,773 | Aug. 25, 2005 | 7,122,070 | Method Of And Apparatus For |
| | | | Electrostatic Fluid Acceleration |
| | | | Control Of A Fluid Flow |
| 10/806,473 | Mar. 23, 2004 | 20040217720 | Electrostatic Fluid Accelerator For |
| | | | And A Method Of Controlling |
| | | | Fluid Flow |
| 10/724,707 | Dec. 2, 2003 | 20050116166 | Corona Discharge Electrode And |
| | | | Method Of Operating The Same |
| 10/752,530 | Jan. 8, 2004 | 20050150384 | Electrostatic Air Cleaning Device |
| 11/046,711 | Feb. 1, 2005 | 20050151490 | Electrostatic Fluid Accelerator For |
| | | | And Method Of Controlling A |
| | | | Fluid Flow |
| 11/119,748 | May 3, 2005 | 20050200289 | Electrostatic Fluid Accelerator |
| 11/214,066 | Aug. 30, 2005 | 20060055343 | Spark Management Method And |
| | | | Device |
| 11/347,565 | Feb. 6, 2006 | 20060226787 | Electrostatic Fluid Accelerator For |
| | | | And Method Of Controlling A |
| | | | Fluid Flow |

each and all of which are incorporated herein in their entireties by reference.

What is claimed is:

1. A method of water treatment comprising the steps of
supplying source water to a corona electrode;
applying a high voltage to said corona electrode relative to a collector electrode sufficient to cause a corona discharge;
collecting processed water from said collecting electrode.

2. The method according to claim 1 further comprising a step of generating ozone and treating said source water with said ozone.

3. The method according to claim 1 wherein said source water includes dissolved salt and said method includes desalination of said source water to remove substantially all of said dissolved salt.

4. The method according to claim 1 wherein said source water includes contaminants and said method includes removal of said contaminants from said source water to provide said processed water.

5. The method according to claim 1 further including a step of maintaining a substantially constant level of said source water.

6. The method according to claim 1 further comprising:
supplying said source water to a constricted portion of said corona electrode;
generating a corona discharge in a vicinity of said constricted portion of said corona electrode;
evaporating said source water under influence of said corona discharge;
transporting the evaporated water to the collecting electrode under influence of an electrostatic field;
condensing the evaporated water at said collecting electrode; and
collecting the resultant condensate.

7. The method according to claim 6 wherein said step of evaporating further comprising a step of heating said water.

8. The method according to claim 6 wherein said step of evaporating further comprising a step of applying pressure to said source water.

9. The method according to claim 6 further comprising a step of atomizing aid source water using an electrospray technique.

10. A method of water desalination and purification, comprising:
flowing salted or contaminated water concentration into a narrow or pointed portion of a corona electrode;
applying an electrical potential difference between the water and an opposite electrode;
generating a corona discharge in said narrow or pointed portion;
evaporating said water;
electrically charging water droplets and molecules formed by said evaporating step by means of the corona discharge;
moving the charged droplets and molecules toward the oppositely charged electrode;
condensing fresh water; and
collecting fresh water.

11. The method according to the claim 10, further comprising the steps of:
generating ozone; and
purifying said water with said ozone.

12. The method according to the claim 10, wherein said step of water evaporating is enhanced with a thermal process.

13. The method according to the claim 10, wherein said step of water evaporating is enhanced by application of pressure to the water.

14. The method according to claim 10 further comprising a step of water atomization created using an electrospray technique.

15. A method of water desalination and purification comprising the steps of:
providing a source of salted or contaminated water supply;
creating sharp edges using hydrophilic pointed objects;
applying a high electrical potential difference between said sharp edges and an opposite electrode;
electrospraying and evaporating water from said sharp edges;
accelerating water droplets and molecules in a direction of the opposite electrodes; and
condensing evaporated water on condensing members as well as in an air gap between said members.

16. A water processing device comprising:
a corona electrode;
at least one attracting electrode;
a power supply generating electrical potential difference between said corona electrode and said attracting electrode; and
at least one water condensing member.

17. The water processing device of claim 16 wherein said attracting electrode and said condensing member are a single unified component.

18. The water processing device of claim 15 operable for the desalination and purification of water.

19. The device of claim 16 further comprising:
a container filled with the salted or contaminated water;
sharp means immersed in said water;
an opposite electrode located outside of said water;
a power supply for supplying the potential difference between said salt water and the opposite electrode; and
a collector for fresh water condensing.

20. The device according to claim 19 wherein said opposite electrodes and said collector are a unified structure.

21. The device according to claim 16 further comprising a water supply operating to maintain water level at a substantially constant level.

22. The device according to claim 16 including a mechanism for maintaining said sharp means at a substantially constant level with respect to a water surface.

23. The device according to claim 16 further comprising a mechanism for maintaining substantially constant a distance between said opposite electrodes and a water surface.
